(19) United States
(12) Patent Application Publication
(10) Pub. No.: US 2005/0169189 A1
(43) Pub. Date: Aug. 4, 2005

(54) Method and device for testing a monitoring function of a bus system and a corresponding bus system

(76) Inventors: Thomas Fuehrer, Gerlingen (DE); Bernd Mueller, Korntal (DE)

Correspondence Address: KENYON & KENYON, ONE BROADWAY, NEW YORK, NY, 10004, US

(21) Appl. No.: 10/510,560

(22) PCT Filed: Apr. 14, 2003
(86) PCT No.: PCT/DE03/01246

(30) Foreign Application Priority Data
Apr. 15, 2002 (DE) 102 16 920.9

(51) Int. Cl. G06F 11/00; H04J 3/14; H04L 1/00; H04J 1/16; H04L 12/26; H04L 12/43

(52) U.S. Cl. 370/252; 370/458

(57) ABSTRACT

A method and device for checking a monitoring function of a bus system and a bus system having at least one user are described, first time slots being provided in which messages are transmitted and a communication cycle being formed from a number of first time slots in such a way that the messages are transmitted in first time slots, the number of first time slots and the particular position of a first time slot for the messages of the user being predetermined in the communication cycle, a second time slot, in which no messages may be transmitted, being provided after the communication cycle and the monitoring function being checked in this second time slot.

### FIELD OF THE INVENTION

The present invention relates to a method and a device for checking a monitoring function of a bus system and a bus system.

### BACKGROUND INFORMATION

The networking of control devices, sensors, and actuators with the aid of a communication system, a bus system, has drastically increased in recent years in the construction of modern motor vehicles or even in mechanical engineering, in particular in the field of machine tools and in automation. Synergistic effects may be achieved in this case by distributing functions to multiple control devices. These are referred to as distributed systems. Different stations communicate increasingly via a bus or a bus system. The communication traffic on the bus system, access and receiving mechanisms, and error management are regulated via a protocol. The CAN (controller area network) is established as the protocol in the field of motor vehicles. This is an event-controlled protocol, i.e., protocol activities such as the transmission of a message are initiated by events having their origin outside the communication system itself. The unique access to the communication system or bus system is triggered via priority-based bit arbitration. A requirement for this is that every message is assigned a unique priority. The CAN protocol is very flexible. Adding further nodes and messages is therefore possible without problems as long as there are still free priorities.

An alternative approach to such an event-controlled spontaneous communication is the purely time-controlled approach. All communication activities on the bus are strictly periodic. Protocol activities such as the transmission of a message are triggered only by the progression of a time that is valid for the entire bus system. Access to the medium is based on the assignment of time ranges or time slots in which a transmitter has the exclusive transmission right. Adding new nodes is possible when the corresponding time slots were previously left free. This circumstance requires the message sequence to be established even before startup, an operating plan being prepared that must fulfill the requirements of the messages in regard to repetition rate, redundancy, deadlines, etc.

In addition to the event-controlled approach and the purely time-controlled approach, a time-controlled CAN approach, the TTCAN (time triggered controller area network), is also known. This fulfills the requirements described above for time-controlled communication and the requirements for a certain degree of flexibility. The TTCAN fulfills these requirements through the construction of the communication cycle in exclusive time windows or time slots for periodic messages of specific communication users and in arbitrating time windows or time slots for spontaneous messages of multiple communication users.

In addition to the cited bus systems, a plurality of bus or communication systems for connecting users in distributed systems are known.

For communication systems and bus systems, there is an array of possibilities for avoiding or solving access conflicts. In CAN, for example, bitwise arbitration is used. This is very robust, but the maximum transmission speed is limited in principle by runtime phenomena. In time-control communication systems, the access problem is solved by approach and configuration. The conflicts are already avoided off-line via prior planning. However, joint agreement on the time having network-wide validity is a requirement. In these systems, however, there is typically no possibility for dealing with the access conflicts in case of error, since the access per se may not be prevented. Therefore, it is typical to introduce a bus guardian or bus monitor BG as an additional unit that allows physical access only in the configured time slots. Therefore, the access conflict may be solved or avoided even in case of error.

As in all monitoring systems, the problem arises here of being able to monitor the monitoring system itself. The essential function of the bus guardian or bus monitor, physically preventing access, is normally never necessary, and thus the availability of this function is also not checked. From a system viewpoint, however, it is necessary to monitor this function to prevent sleeping errors. German Published Patent Application No. 199 50 433 is known as the related art in this regard. It describes a method for monitoring this function. However, the cited related art has the disadvantage that the bus guardian function is checked or monitored in a time slot that would typically be used for message transmission, but may not be used for this purpose during the check. This means that time that would normally be provided for transmitting messages is used within the regular communication time for the benefit of the bus guardian tests.

Therefore, it has been shown that the cited related art is not capable of providing optimal results in every aspect. This results in the object of optimizing the above-mentioned situation and overcoming the disadvantages resulting from the related art.

### SUMMARY OF THE INVENTION

The present invention is directed to a method and a device for checking a monitoring function of a bus system and a corresponding bus system having at least one user, first time slots being provided in which messages are transmitted and a communication cycle being formed from a number of first time slots in such a way that the messages are transmitted in first time slots, the number of first time slots and the particular position of a first time slot for the messages of the user being predetermined in the communication cycle, a second time slot, in which no messages may be transmitted, now advantageously being provided after the communication cycle, the monitoring function being checked in this second time slot.

The major advantage of the present invention is thus that no time which is normally provided for transmitting messages must be used within the communication cycle for the benefit of the bus guardian test. The proposed test instant is therefore within a second time slot that is not used for active communication, the network idle time NIT.

The monitoring function is expediently implemented in such a way that the messages of the user that are transmitted outside the first time slots provided for these messages are blocked.

Furthermore, it is expedient if internal protocol tasks of the user, which would have to be processed anyway in the course of cyclic housekeeping, are processed in the second time slot. These expediently include, for example, determining a time correction value in order to adapt a local time of a user to a global time of the entire bus system.

The monitoring function is expediently checked in such a way that the user attempts to transmit a test message in the second time slot and checks whether this test message was blocked. This has the advantage that the user may read back the self-sent message from the bus system and therefore performs its own check of whether the test message was blocked, i.e., an advantageous loop-back function exists.

In an advantageous embodiment, the test message has a unique signal form in the bus system in order to differentiate it from transient irradiation, in the framework of electromagnetic compatibility problems, for example.

Each user expediently performs its own check of the monitoring function, only a single user being able to perform the check of the monitoring function simultaneously.

In a further advantageous embodiment, a concrete time slot is uniquely assigned to the user for the check. This may be a third time slot within a second time slot or a concrete time slot after a concrete communication cycle, so that which user may perform a check in which time slot is clearly established.

Furthermore, it is advantageous if each user is assigned its own test message, the test messages of the individual users differing from one another.

It is advantageous in this case if a test message assigned to a user may only be received by one user, specifically the user to whom it is assigned.

If each user is uniquely assigned a test message or a time slot, at least one second user may also expediently check the monitoring function of a first user and communicate a result of this check to the first user.

In a special embodiment, the bus system is constructed in a star topology, each user having a connection to a coupling element of the bus star and the coupling element being implemented in such a way that a test message of a user is not relayed by the coupling element to further users, so that each user may uniquely perform a self-check.

### BRIEF DESCRIPTION OF THE DRAWINGS

FIG. 1 shows a bus system having at least one user, two users in particular, to illustrate the method according to the present invention.

FIG. 2 shows the monitoring of the bus guardian function according to the present invention in the framework of a signal illustration.

FIG. 3 shows a special embodiment of a bus system in star topology having a coupling element.

### DETAILED DESCRIPTION

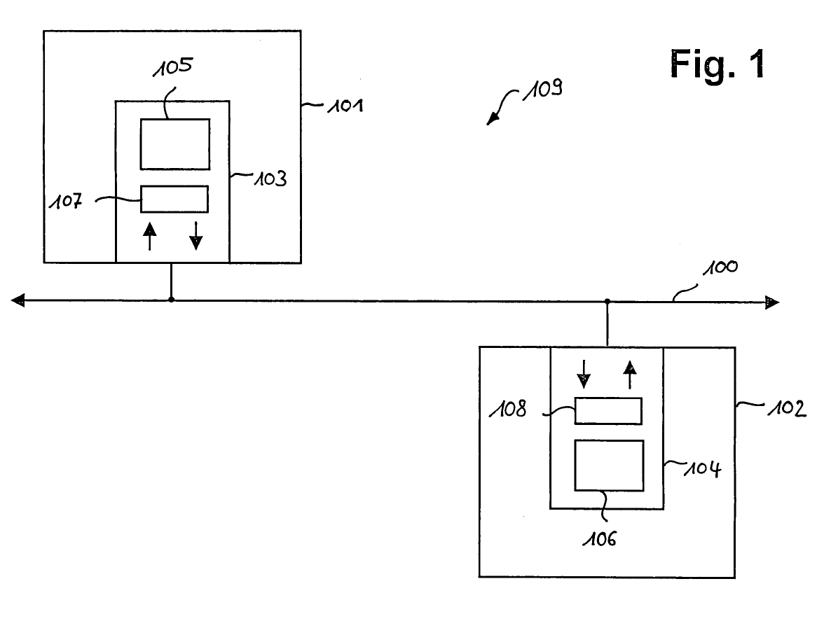

FIG. 1 shows a communication network or communication system, a bus system 109, having a bus 100. Users 101 and 102, each of which contains a coupling element, in particular a bus controller 104 and 103, respectively, are coupled to this bus. Symbolically shown in bus coupling units 103 and 104, respectively, are processing unit 105 and 106, respectively, as well as an associated bus monitor or bus guardian or the corresponding function with block 107 and block 108, respectively. The positioning of the processing unit, bus controller, bus interface, and monitoring function is to be viewed as exemplary in this case. The processing and the monitoring function may also be performed directly in the user. In this case, any arbitrary assignments of the processing function and monitoring function to the bus controller or user itself are possible. External positioning of the cited components and functions in relation to the user is also conceivable.

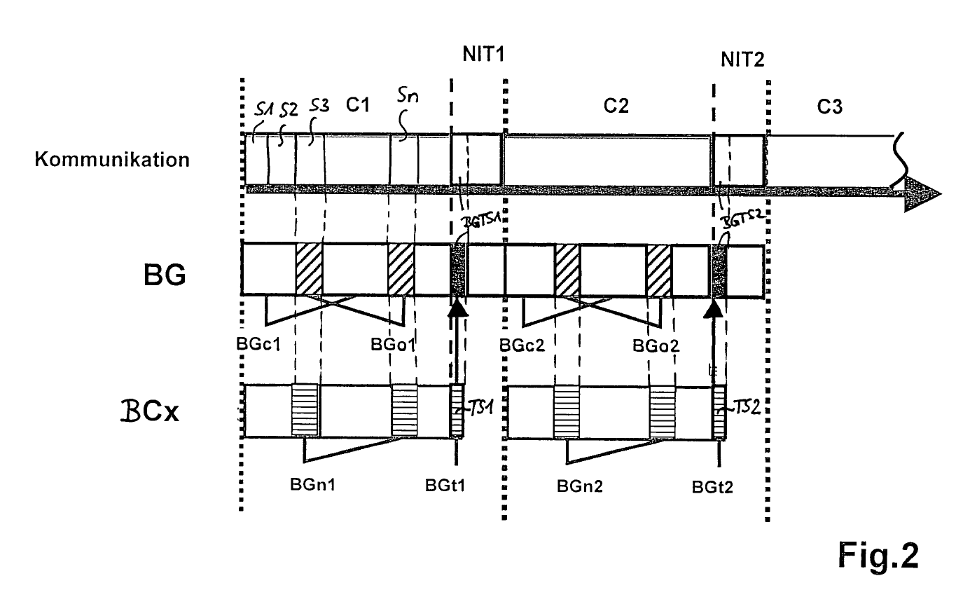

FIG. 2 now shows the communication on the bus with a first communication cycle C1, a communication cycle C2, and a communication cycle C3. In this case, the communication cycles are divided into a plurality of time slots, shown here for exemplary purposes by time slots S1, S2, S3, or Sn. Each communication cycle C (C1, C2, . . . ) is followed by network idle time NIT, here NIT1 for C1 and NIT2 for C2. This network idle time is a period of time that may be added to the current communication cycle, but in which no messages may be transmitted. By definition, important internal protocol tasks such as the calculation of the clock correction values to adapt a local time of an individual user to the global time of the entire bus system are performed in the network idle time. If there are no errors, no single controller or bus controller BC transmits in network idle time NIT, and bus guardian BG has to protect this range for all controllers. For this purpose, a separate time line is shown for the bus guardian and for corresponding optional bus controller BCX. A requirement for an informative end-to-end test is that a transmission attempt is undertaken and its prevention is checked by the bus guardian.

A requirement for the method is that the transmission sequence of the communication system is constructed cyclically and is structured in communication cycles. It is advantageous if each node and/or user or bus controller has the possibility of detecting when the test has a negative result, i.e., it reads back the actual signals via a loop back. In segments BGC1 and BGC2, respectively, the bus guardian blocks the transmission ability via bus controller BCX. This controller has the possibility of transmitting normal messages, i.e., here BGN1 and BGN2, respectively, to the bus in the time slots provided for it, S3 and Sn in this case. In these time slots, the message transmission by bus controller BCX is released by bus guardian BG, as is shown by BGO1 and BGO2.

According to the present invention, a bus guardian test is thus not performed in the time available for communication, but rather in a time in which no communication is allowed and/or provided on the bus, during the network idle time. For this purpose, a controller, in this case BCX, may transmit a signal, particularly a test signal, shown here with TS1 and TS2, respectively, during the network idle time, it then being checked whether this transmitted signal or this transmitted message is visible on the bus. If the message is visible on the bus, the block was faulty. Therefore, if the corresponding test signal is able to be detected on the bus in slots BGTS1 and BGTS2, the block has not been performed by the bus guardian and the monitoring function is faulty.

Signals TS1 and TS2 are transmitted as test signals or test messages by bus controller BCX, which is shown as BGT1 and BGT2, respectively. Therefore, if the corresponding bus controller or the corresponding processing unit transmits a signal during the network idle time and it sees nothing on the bus, its signal was not able to pass the bus guardian block, thereby showing that the operational performance of bus guardian BG in regard to blocking is effective. In the negative case, the operational performance in regard to opening transmission slots BGO1 and BGO2, respectively, may also be checked in this manner. If the test or the check of the monitoring function of the bus guardian returns a signal, there are different possibilities for determining whether a particular node has the error. First, a general differentiation between errors and transient irradiations is possible by presetting specific signal forms and repeating the test. This means that the test message or the test signal is uniquely assigned a signal form, so that it may be recognized and differentiated from other signals. For confirmation, the test may also be repeated in order to differentiate a single irradiation or a single faulty signal from a systematic error.

Furthermore, it may be predetermined that two nodes and/or two users or bus controllers and/or the processing units perform the check of the bus guardian function at the same time. This may be performed in one way by assigning each user or bus controller a concrete time slot in the network idle time, for example, BGTS1 and BGTS2, respectively. In addition, a complete network idle time, such as NIT1 or NIT2, may be assigned to a specific bus controller, so that, for example, bus controller 103 may perform the test of the bus guardian function after the corresponding communication cycle in NIT1, and bus controller 102 may perform the test in NIT2.

Specifically, if such an assignment of specific time slots or even unique signal forms of the test messages from the corresponding user to the particular user is not performed and if all nodes could perform the test at the same time, signals being able to propagate from one node to all others, a node is not able to interpret a signal measured as different from 0 as an error without something further or the error analysis will not be unambiguous.

In order to prevent this, for example, it is possible to concretely assign the test performance of a communication cycle to associated network idle time NIT or even to concretely reserve time slots in the NIT for test runs, so that, in some instances, multiple test runs in one NIT are possible.

Whenever it is ensured by configuration and/or through prior measures that two test performances and/or checks of the monitoring function of different nodes may not overlap, a test signal may be classified as an error indication for the node just tested.

In addition, if tests overlap in time, the possibility may still be provided of making a unique error identification possible, just through different test signals that are assigned to each tester or node or something similar. This means that the signal form of the test signal or the test message may differ from user to user, and bus guardian to bus guardian. It is then also possible for bus guardian monitoring to be performed not by each individual user, but rather by one user for another user, for example, by user 101 for user 102. This is also true if a specific time slot is assigned to the test, as described above, so that other nodes may then judge the success of the test and may communicate a test result to the user tested via a suitable acknowledge within the scope of the protocol mechanism or an explicit message, for example.

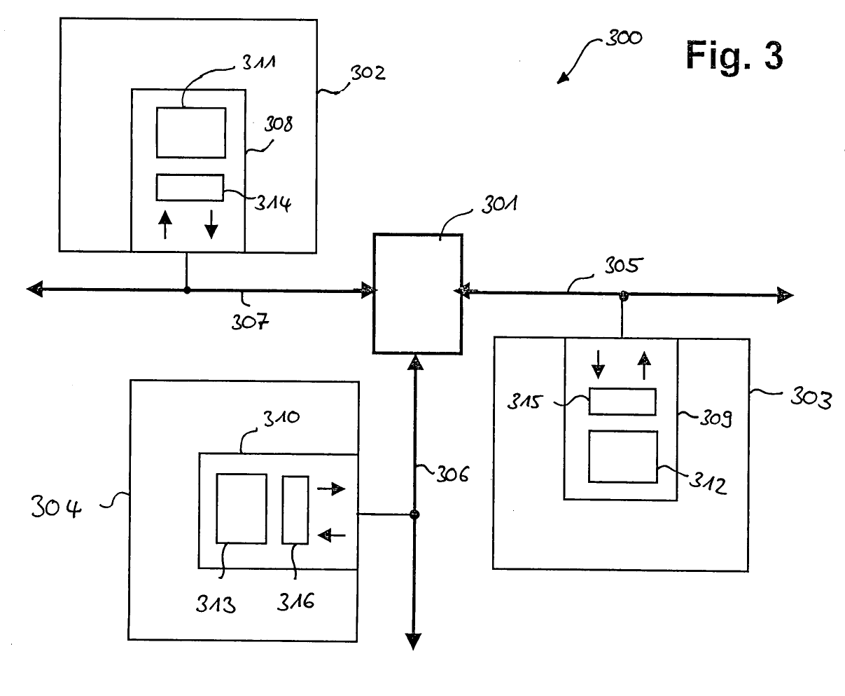

A bus system in star topology represents a special embodiment, as is illustrated in FIG. 3. In this case, bus users 302, 303, and 304 are again shown, each of which contains a bus controller 308, 309, and 310, respectively. As in FIG. 1, a processing unit 311, 312, and 313, respectively and the bus guardian function or monitoring of bus guardian function 314, 315, and 316 are again shown therein. The same requirements and assumptions and possibilities apply to the users and the corresponding bus controllers as in FIG. 1. These users are now each coupled to a bus 305, 306, and 307, respectively. The users and the corresponding buses are connected via a coupling element 301. In this shown star topology, the physical properties of the star may be used and the test signals or the test messages may be selected in such a way that they do not propagate through a star. This means that the n users of a star coupler may be tested simultaneously, since the star does not connect through the test signal and tests each user on its local connection, i.e., user to star, in this case buses 305, 306, 307, and performs the corresponding loop back. Overlapping of the messages and the test performances in the course of monitoring the bus guardian function is thus prevented in this case by the topology of the star.

Therefore, in contrast to the related art, an advantageous expansion is achieved that allows stronger rationalization of the bus load.

1-18. (canceled)

19. A method for checking a monitoring function of a bus system having at least one user, comprising:
providing first time slots in which messages are transmitted;
forming a communication cycle from a number of first time slots in such a way that the messages are transmitted in the first time slots, the number of first time slots and the particular position of a first time slot for the messages of the user being predetermined in the communication cycle, wherein a second time slot is provided after the communication cycle, in which no messages may be transmitted; and
checking the monitoring function in the second time slot.

20. The method as recited in claim 19, wherein the monitoring function is implemented in such a way that the messages of the at least one user that are transmitted outside the first time slots provided for these messages are blocked.

21. The method as recited in claim 19, further comprising:
processing internal protocol tasks of the at least one user of the bus system in the second time slot.

22. The method as recited in claim 21, further comprising:
determining a time correction value as an internal protocol task, in order to adapt a local time of the at least one user to a global time of the bus system.

23. The method as recited in claim 19, further comprising:
checking the monitoring function in such a way that the at least one user attempts to transmit a test message in the second time slot, and whether the test message was blocked is checked.

24. The method as recited in claim 23, wherein the user is able to read back the self-sent messages from the bus system and therefore performs its own check of whether the test message was blocked.

25. The method as recited in claim 24, wherein:
the test message has a unique signal form in the bus system in order to differentiate itself from transient irradiations.

26. The method as recited in claim 19, wherein:
each user performs its own check and the check of the monitoring function can only be performed by a single user simultaneously.

27. The method as recited in claim 19, wherein:
each user is assigned a third time slot that lies inside the second time slot in which only the corresponding user can check the monitoring function.

28. The method as recited in claim 19, wherein:
each user is assigned the second time slot after the communication cycle in which only the corresponding user can check the monitoring function.

29. The method as recited in claim 28, wherein:
each user performs its own check.

30. The method as recited in claim 23, wherein:
the test message has a unique signal form, and
a unique test message is assigned to each user, the test messages of the individual users differing from one another.

31. The method as recited in claim 29, wherein:
a test message assigned to a user can only be received by that one user.

32. The method as recited in claim 23, wherein:
one of a test message and a time slot is uniquely assigned to each user, and at least one second user performs the check of the monitoring function of a first user.

33. The method as recited in claim 32, wherein:
the at least one second user transmits a result of the check of the monitoring function of the first user to the first user.

34. A device for checking a monitoring function of a bus system having at least one user, comprising:
an arrangement for providing first time slots in which messages are transmitted;
an arrangement for forming a communication cycle from a number of first time slots in such a way that the messages are transmitted in the first time slots, the number of first time slots and the particular position of a first time slot for the messages of the user being predetermined in the communication cycle, wherein a second time slot is provided after the communication cycle, in which no messages may be transmitted; and
an arrangement for checking the monitoring function in the second time slot.

35. A bus system having at least one user, comprising:
an arrangement for providing first time slots in which messages are transmitted;
an arrangement for forming a communication cycle from a number of first time slots in such a way that the messages are transmitted in the first time slots, the number of first time slots and the particular position of a first time slot for the messages of the user being predetermined in the communication cycle, wherein a second time slot is provided after the communication cycle, in which no messages may be transmitted; and
an arrangement for checking a monitoring function of the bus system in the second time slot. A bus system having at least one user for checking a monitoring function, first time slots being provided in which messages are transmitted and a communication cycle being formed from a number of first time slots in such a way that the messages are transmitted in first time slots, the number of first time slots and the particular position of a first time slot for the messages of the user being predetermined in the communication cycle, wherein a second time slot is provided after the communication cycle, in which no messages may be transmitted, and means are included that check the monitoring function in this second time slot.

36. The device as recited in claim 34, wherein:
the bus system has a star topology,
each user has a connection to a coupling element of the bus system in the star topology, the coupling element being implemented in such a way that a test message of a user is not relayed by the coupling element, the coupling element being included in each user.

37. The device as recited in claim 35, wherein:
the bus system has a star topology,
each user has a connection to a coupling element of the bus system in the star topology, the coupling element being implemented in such a way that a test message of a user is not relayed by the coupling element, the coupling element being included in each user.
